(19) United States
(12) Patent Application Publication
(10) Pub. No.: US 2025/0144681 A1
(43) Pub. Date: May 8, 2025

(54) A BATCH SYSTEM FOR THE PRODUCTION OF CHEMICAL COMPOUNDS AND/OR GASES FROM A PYROLYZED PLASTIC WASTE FEEDSTOCK

(71) Applicant: BRIGHTMARK PLASTICS RENEWAL TECHNOLOGIES LLC, San Francisco, CA (US)

(72) Inventors: Mehmet A. GENCER, Brecksville, OH (US); Richard K. PETERSON, Huntertown, IN (US); Jay SCHABEL, Hiram, OH (US)

(21) Appl. No.: 18/838,053

(22) PCT Filed: Feb. 16, 2023
(86) PCT No.: PCT/US2023/013196

§ 371 Date: Aug. 13, 2024

Related U.S. Application Data
(60) Provisional application No. 63/311,705, filed on Feb. 18, 2022.

(51) Int. Cl. B09B 3/40; B09B 101/75; C10B 53/07

(52) U.S. Cl. CPC B09B 3/40; C10B 53/07; B09B 2101/75

(57) ABSTRACT

A plurality of pyrolytic batch reactors that operate on a sequential time basis to transform plastic waste material to chemical compounds and/or gas products along with a solid inert residue. The operation insures a steady, intermittent high output of a product with very little, if any, downtime. Contaminants and undesired by-products, such as vapors, are removed in a staged manner prior to the recovery of the desired pyrolytic product.

### FIELD OF THE INVENTION

The present invention relates to generally producing chemical compounds or gases, or both, from a plurality of batch reactors that independently pyrolyze plastic waste in a sequential time manner.

### BACKGROUND OF THE INVENTION

Proper and environmentally disposal of waste materials, including plastic waste, is a problem throughout the world including the United States of America. Various proposed solutions that generally have been found to be insufficient range from simply burying the waste material as in a landfill to attempts to chemically modify the plastic waste and produce recycled chemical compounds. Chemically converting the plastic is preferable to landfilling as it conserves the fossil resources used to make the plastic. However, solutions for recycling and chemical conversion of waste plastics commonly struggle with mixed waste plastics, contaminants such as food waste, chlorides, and dyes. Accordingly, overall recycling rates for plastic are quite low, and recycled resins struggle to compete economically with virgin plastics. Pyrolysis is more tolerant of mixed wastes and contaminants, and makes hydrocarbons that are suitable for fuels, lubricants, waxes, and even processing back into virgin quality polymers.

### SUMMARY OF THE INVENTION

The present invention overcomes these problems by utilizing a plurality of batch reactors having limited process times that chemically modify the plastic waste and produce chemically modified compounds such as various pyrolyzed oils and gases. Examples of such compounds include diesel fuel, gasoline, heating oil, natural gas, kerosene, lubricants, waxes, and various gas products such as alkanes, e.g. methane, ethane, propane, butane, pentane, and alkenes, as well as isomers thereof, or any combination thereof. Since the various C₁ to C₅ alkanes are generally gases at room temperature, they are typically utilized as recycled gas that is fed to a heater H₁ through H₅, etc., of a pyrolyzation system such as shown in FIG. 2.

The present invention generally relates to a plurality of batch reactors that are operated in a sequential time manner with respect to the charging thereof producing the various above-noted chemical compounds and gases, and subsequently discharging the same from the batch reactor. Such sequential production by the plurality of batch reactor have been found to be an efficient and workable method that produces high output amounts of said various oils and gases with reduced contaminant levels.

In general, a method of producing and recovering chemical compounds, or gas products, or both, from a plastic waste feedstock comprises the steps of providing a plurality of individual pyrolytic batch reactors, at least one said pyrolytic reactor independently being capable of converting said plastic waste to said chemical compounds, or said gas products, or both, and also a Solid Inert Residue (SIR). The method involves charging, independently, in a sequential time manner said plastic waste feedstock to at least two of said pyrolytic reactors; pyrolyzing, independently, in a sequential time manner at least one of said individual batch reactors containing said plastic waste feedstock; and producing and emitting said chemical compounds, or gas products, or both, as well as said solid inert residue (SIR), in an independent time sequence manner from said at least one of said individual pyrolytic reactors.

### BRIEF DESCRIPTION OF THE DRAWINGS

The foregoing and other features of the present invention will become apparent to those skilled in the art to which the present disclosure relates upon reading the following description with reference to the accompanying drawings, in which:

FIG. 1 is a schematic graph of a plurality of batch reactors that sequentially transform charged pyrolytically plastic waste into suitable compounds and/or gases, and discharge the same, according to the present invention;

FIG. 2 is a view of a plastic waste pyrolytic reactor according to the present invention; and

FIG. 3 is a graph showing charging, pyrolyzing, and discharge times of six batch reactors.

### DETAILED DESCRIPTION OF THE INVENTION

A process and apparatus for a high output of chemicals and gases derived from the systematic pyrolyzation of plastic waste feedstock is set forth that is an environmentally friendly system and saves copious amounts of said waste from being disposed of in landfills, oceans, and the like. The present invention does not relate to a continuous input of feedstock into a pyrolytic reactor such as a 24-hour, seven-day-a-week operation but rather to a plurality of individual pyrolytic reactors that are sequentially charged or fed, within a limited charging time, a fixed or limited amount of plastic waste feedstock; reacting the feedstock for a limited time of usually a few hours, generally with two or more time stages to allow undesirable components to be preferentially recovered separately from the final product, wherein generally most and desirably all of the feedstock has been has been fully converted to chemical compounds and/or gases. Upon completion of the pyrolytic reaction cycle, i.e. reaction step, the remaining chemical compounds and gases are discharged, i.e. produced and emitted from the reactor. An important aspect of the discharge cycle or step is the complete removal of any remaining SIR (solid inert residues) that tends to remain or hang up in the pyrolytic reactor and must be removed as by airlock valves, pistons, augers, and the like. Subsequently, the batch reactor is ready for repeating the three above-noted cycles of charging a pyrolytic reactor, pyrolyzing the feedstock therein, and finally discharging or removing any remaining gases, liquids, and importantly any remaining SIR material. According to the present invention, a series of reactors are utilized that operate in a sequential time basis that avoids costly and time-consuming slow-downs and/or termination that otherwise can occur in a continuous (24/7) pyrolytic operation, i.e. wherein the feedstock is fed continuously during the course of at least several days to a pyrolytic reactor. Also, such continuous reactors are subject to various failures or break downs of the pyrolytic reactor mechanisms, such as improper heating, over or under feeding of the plastic waste material, unsuitable compounds contained in the plastic waste feedstock, buildup of residues, coking, and the like.

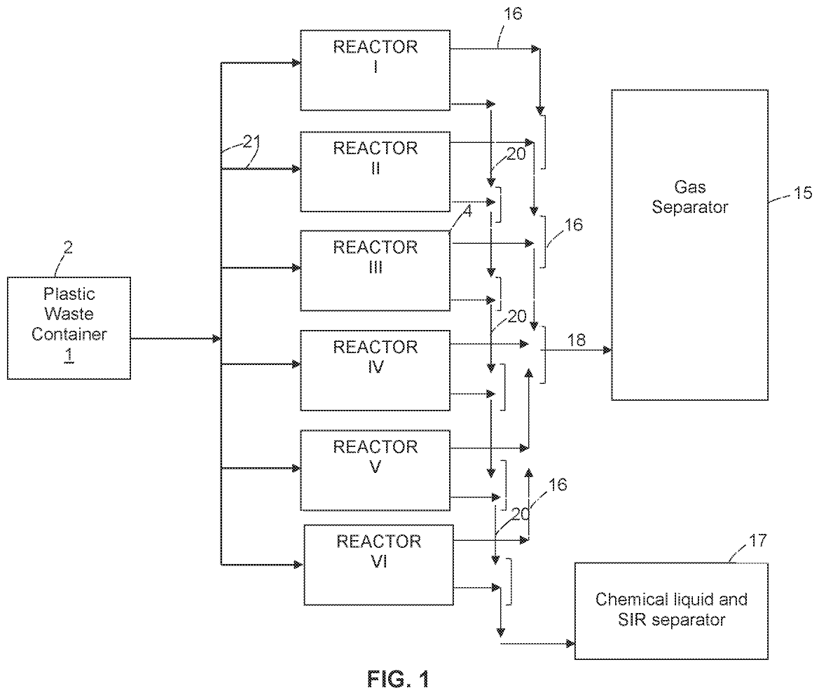

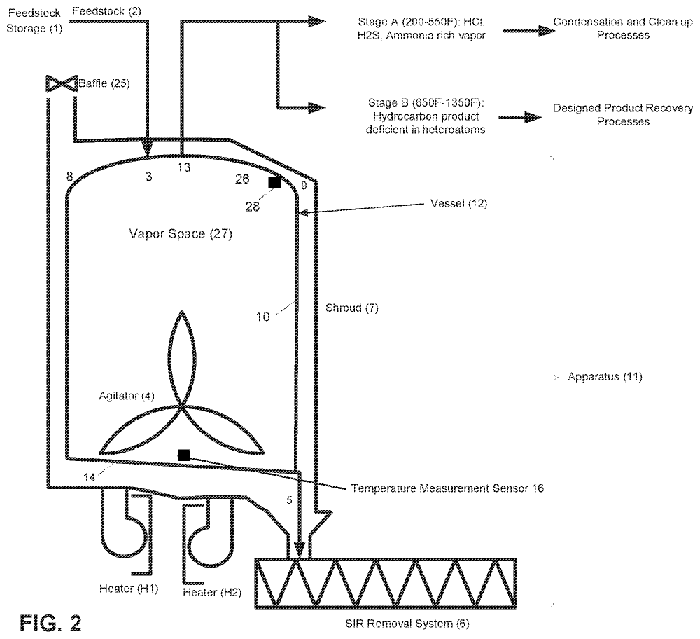

Referring to FIG. 1, a plurality of batch reactors are set forth wherein the operation of any given set of reactors are generally arranged in a time sequential order, with regard to a reactor production cycle, e.g. charging, pyrolytic reactions, and discharging. In other words, in order to achieve an orderly disposition of a plastic waste feedstock, the multiple reactors are operated on a timely sequential basis with respect to one another. The number of such pyrolytic reactors can vary widely such as from about at least 2 to about 12, often from about 4 to about 9, and preferably from about 5 to about 7. While it is to be understood that many modifications can be utilized, the operation of charging the batch reactor system of the present invention, e.g. FIG. 2, is generally as follows: plastic waste or feedstock 2 contained in plastic waste container 1 is conveyed or fed via one or more feed lines 21 to the various individual reactors I through VI, FIG. 1, in an independent, sequential time manner utilizing a standard feed mechanism such as a conveyor, auger, extruder, airlock valves, and the like. The feedstock is initially and preferably only fed to reactor I, subsequently only to reactor II, then subsequently to only reactor III, etc. In the embodiment shown in FIG. 1, six reactors are utilized with the last reactor, i.e. reactor VI being charged last. More specifically, feedstock 2 is fed to opening 3 of the reactor shown in FIG. 2. The charging time between feedstock addition can range from about 15 to about 180 minutes, desirably from about 60 to about 150 minutes, and preferably from about 110 to about 130 minutes, i.e. about 2 hours.

Once the total finite amount of feedstock has been charged into the reactor, heaters H₁ and H₂ initiate a reaction or pyrolyzation step that generally lasts from about 30 to about 300 minutes, desirably from about 60 to about 180 minutes, most preferably 90-120 minutes. Numerous pyrolyzation methods can be used such as temperatures range of from about 500° F. (260° C.) to about 1500° F. (816° C.), and desirably from about 700° F. (371° C.) to about 1300° F. (704° C.), and preferably from about 800° F. (427° C.) to about 1100° F. (593° C.) step or cycle. During the pyrolyzation reaction feedstock 2 is gradually moved in or through reactor vessel I, II, III, etc. by a conventional transferal device such as a helical screw, a conveyor, an assembly line, etc., by a mixing device. In a manner such as set forth hereinbelow, the various compounds of feedstock 2, in the absence of any oxygen, are pyrolyzed at the above-noted temperatures. During the pyrolyzing step, various compounds of the feedstock are cracked, and/or recombined, and the like whereby various pyrolyzed oils, gases, and SIR materials are formed. The pyrolyzation reaction time can vary but desirably is approximately the same for each reactor of the six noted reactors set forth in FIG. 1. That is, from at least 0.5 hours to about 6 hours, or any other pyrolyzation time period, with about 3.5 to about 4.5 hours being preferred. There are also time duration stages in the reaction time, for example stage one could be the first hour of reaction time, and stage 2 the rest of the reaction time. During these time duration stages, different compounds are yielded. For example, in time stage 1, the vapor can preferentially contain chlorides and or other contaminants that can be condensed separately and removed, thus reducing the contaminant load in the final product from stage 2. The structure of the various pyrolytic reactors such as shown in FIG. 2 is set forth hereinbelow. As set forth with respect to the charging cycle, the pyrolytic reaction cycle generally is controlled so that the overall reaction time period is approximately the same.

The pyrolysis vapors from the batch reactor are collected by pipe or duct and fed to a gas separator condensation system. The condensation system can be a direct contact type, such as a spray tower, trayed tower, or venturi type mixer with recirculating; or more typical condenser designs such as air coolers or shell and tube condensers. The cooling method can be direct or indirect such as with already condensed liquids or using air, water, heat transfer oils, and the like.

Alternatively, the produced gases of the pyrolyzation reaction cycle, as shown in FIG. 1, can be fed, from each reactor I through VI to gas separator 15 via discharge pipeline or duct 18. The pyrolyzed liquid chemical compounds and SIR compounds produced are generally conveyed from the bottom of the individual reactor as shown in FIG. 1 through pipeline 20 to chemical liquid and SIR separator 17. Each pyrolyzing reactor is sequentially operated with respect to an adjacent reactor. For example, upon termination of discharging the chemical compounds and/or gases from batch reactor I, in a delayed subsequent or in a sequential time manner or period thereafter, reactor Il is discharged with the gas also going to separator 15 and the liquid chemical compounds going to separator 17. Thus, plastic waste material 2 in container 1 is timely and sequentially pyrolyzed in reactors I through VI.

The chemical liquid and SIR separator can be a flash vessel, some form of dryer, or the like for removing entrained liquids from the solid SIR material. It also has a means for removing SIR material from the system while maintaining a vapor seal. This may be through airlock valves, pistons, augers, and the like.

The batch pyrolyzing reactor system of the present invention is generally more efficient than a continuous reactor system. That is, the individual pyrolyzation of limited amounts of plastic feedstock, such as during the above-noted charging period, result in an efficient fracture, recombination, breaking up of molecules, etc., as opposed to the continuous operation of a 24 hour, at least a 7 day a week cycle. Apparently, the start-stop limited time pyrolyzation of an amount of the feedstock results in quicker production of the various above-noted pyrolyzed oils, gases, and the like. In other words, unexpectedly the batch pyrolyzation system of the present invention is more efficient and yields a higher output of pyrolyzed product than a continuous pyrolyzation process. Additionally, the sequencing batch allows for separation of undesired contaminants such as chlorides, sulfur, ammonia, and the like, by enriching them in a time staged product, where in a continuous reactor these contaminants are equally distributed in all of the product. Heteroatoms, e.g. a halide, and other contaminants and vapors as noted herein, can be removed early in the total reaction run time that can generally range from about 15 to about 60 minutes, desirably from about 20 to about 50 minutes, and preferably from about 25 to about 40 minutes.

The final processing step of the batch reactor pyrolyzing process of the present invention is the discharge of the various produced pyrolyzed oils, gases, and SIR compounds. In general, upon termination of the pyrolytic reactions occurring in the pyrolytic vessels 12 of the present invention, the remaining oils and gases within the reactor are withdrawn and recovered. The remaining SIR material, that is the compounds that are not fractionated, can be in the form of broken, shorter molecular chains, and the like, are retained within the reactor such as the solid residue discharge material 5 as shown in the bottom right-half side of FIG. 2. Any material not previously collected in a discharge reservoir, not shown, is removed by various means from the pyrolytic reactor during the discharge cycle once temperatures have been generally reduced to ambient. Methods of removal include augers, conveyors, air conveyors, pistons, and the like. Due to the fact that the SIR is a solid material, generally a long period of time is required to remove the same. Suitable down times generally range from about 1 to about 6 hours, desirably from about 1 to about 3 hours, and preferably about 2 hours. Once material is removed, the reactor is ready to be charged as set forth hereinabove and the above cycles of charging, pyrolytic reaction and discharge are repeated time after time.

Operating in a sequencing batch fashion allows for different conditions to be present in the reactor during different steps, which facilitate important results. For example, during removal of the SIR, pressure in the reactor can be reduced such that less leakage would be experienced through seals in the SIR removal system. This simplifies design and makes operation of the SIR removal system safer. However, a lower process pressure may not be favorable during the reaction and lead to lower yields. Sequencing these steps allows for optimization of conditions for each. Another example is that certain reactions occur in different conditions that can be beneficiated in a sequencing batch reaction. Dechlorination of PVC generally happens at lower temperatures than pyrolysis of the hydrocarbon chains. Accordingly, by operating in a sequencing batch, dechlorination can be done separate from bulk pyrolysis, allowing for a reduction of the chlorides in the final product by time sequencing. In practice, the gases can be condensed separately at the beginning and end of the run with different condensers or by emptying the product vessel in the middle of the run to exclude halogens, especially chlorides, from the designed products which are condensed later in the batch run.

The pyrolytic reaction system of FIG. 2 of the present invention with respect to feedstock or plastic waste 2 produces various chemical compounds as set forth above including major amounts of petroleum gases such as paraffins, isoparaffins, olefins, naphthenes, and aromatics.

A unique advantage of the present pyrolytic batch reactor system such as set forth in FIG. 1 is that should any problem occur in any individual reactor, the system continues to operate in that the particular, individual non-functioning or malfunctioning reactor can be closed down while the remaining reactors continue to fully operate. The subsequent reactors can be operated on the same original time basis, or advanced.

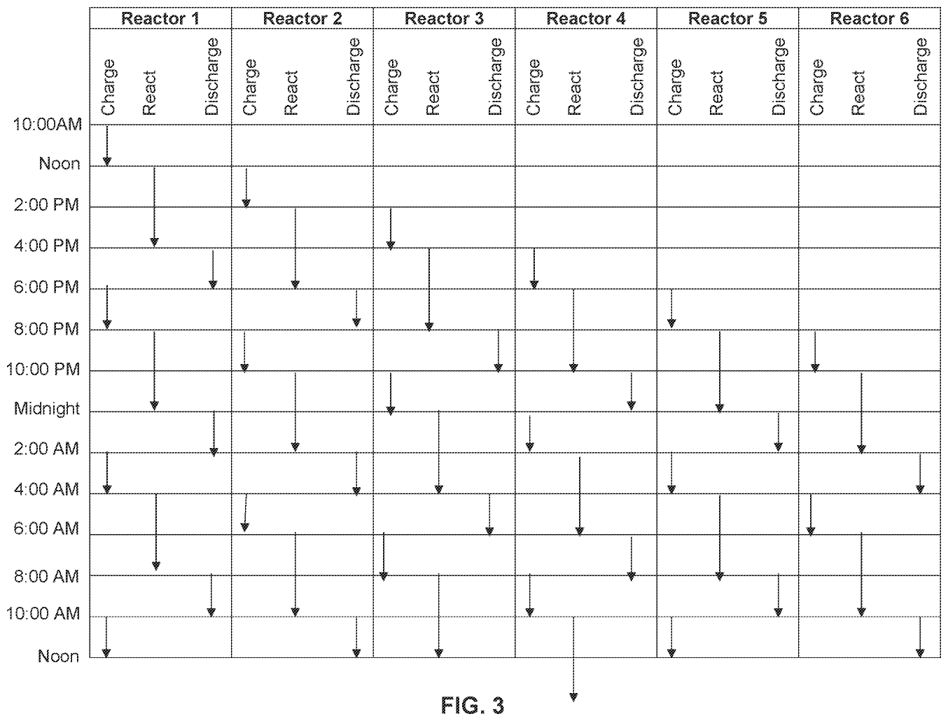

Example production cycles of the various six reactors are set forth in FIG. 3. Not only does the time sequence of the present invention aid in producing a high output, but the delayed time sequence provides ample time for human operators of the system to tend to the various production cycles, for example charging, pyrolyzing, and discharging any remaining reactants. With regard to each reactor, sets of three downward pointed arrows are shown that relate to the various sequential production cycles. The left arrow represents the time of charging the feedstock, the center arrow represents the time with regard to the pyrolyzation process, and the third arrow on the right side of each column represents the discharge and cleaning time of the reactor. As apparent from FIG. 3, each subsequent reactor has initial charge of feedstock of about 2 hours. The reaction time period is approximately 4 hours and the discharge or clean-up cycle is approximately 2 hours. Of course, as should be apparent to one skilled in the art, the various time cycles can vary depending upon the type of reactors utilized, the individual characteristics thereof, the number of reactors utilized, and the like. Thus, numerous different types of sequential pyrolyzation of waste feedstock exists.

It is desirable to have as many, and preferably all of the reactors pyrolyzing the waste feedstock within ranges with respect to property values and structural values as set forth herein. Property values generally include low amounts of oxygen within the reactor, that the free volume is generally above at least 60% and preferably above 80%, and that the pyrolyzing temperatures are as noted above. Structural value limitations include utilization of a shroud 7, heaters H₁, H₂, etc., heated fluid channels such as 8 and 9. However, it is within the scope of the present invention that one or more individual pyrolytic batch reactors can operate outside of the desired and preferred ranges set forth herein. That is, generally the present invention can relate to a very low amount of reactors operating within the various parameters of the invention such as at least two reactors, or at least 10% or more of the reactors, desirably at least 25% or more, and preferably at least 45% or more of the total individual pyrolytic batch reactors. However, in order to be efficient, it is highly desired that at least 75%, desirably at least about 85%, and most preferably at least 95%+ of the reactors operate within the indicated property values and structural values of the present invention.

In summary, while the plurality of pyrolytic batch reactors operate independently with respect to one another, and generally have similar operating parameters each pyrolytic reactor also can be operated with different operating parameters such as reaction times of the plastic waste feedstock therein, the type of individual waste feed, pyrolytic reaction temperatures, discharge times, as well as the time period between charging subsequent reactors, and the like. The end result of such pyrolytic batch reactor systems as set forth in FIG. 1, is an intermittent but steady discharge of the noted produced chemical compound and/or gases.

In order to obtain a smooth operation of the batch reactors of the present invention, is desired that the following items, compounds, etc., are not utilized. For example, the plastic waste feedstock container 1 is free of any acidic compounds and other undesirable compounds such as, halogens, metals, minerals, fiber, wood or food wastes. By the term “free of” it is meant that any amount utilized is small, such as less than about 10% by volume, desirably less than about 2%, and preferably nil, there is no undesired compound utilized whatsoever. Another operating feature of the batch reactors of the present invention is that heat is directly introduced to the reactor vessel 12 from the bottom 14 of the vessel 12. The heat is supplied into the reactor also through internal spaces or fluid channels 8 and 9 that are located between reactor vessel wall 10 and outer shroud 7. The pyrolytic batch reactor generally contains a helical screw, anchor mixer, or other type of agitator 4 therein and does not contain (is free of) any internal perforated plates. As noted hereinbelow, the reactors are initially purged of oxygen. The amount of any oxygen in a reactor is less than about 3%, desirably less than about 2%, and preferably less than about 1.0% by volume of the entire volume of the reactor. They are also purged of water or any water vapor (e.g. steam) and hence are generally water-free. That is, the amount of any such water is small, generally less than about 5%, desirably less than about 2%, and preferably less than about 1% by volume. Another negative limitation is that the plastic waste feedstock and the like does not contain any oil therein such as shale oil or the like which would reduce the recycled plastic content of the product. If contained, only a small amount is contained such as about 10% or less by volume, desirably about 3% or less, or nil, that is no oil whatsoever.

The invention will be better understood by the following description of the preferred components of the pyrolytic batch reactors that can be utilized in the present system that generally operate on the same principle and have the same structure, properties, and feedstock as set forth hereinbelow.

The feedstocks invariably are mixed polymers of at least two different polymers, for example, a mixture of two or more of thermoplastic polymers, thermoset polymers, or blends thereof.

Polymer materials can include one or more of the following thermoplastic polymers, thermoset or sustainable biopolymers, or any combination thereof. For example, polyethylene, polypropylene, polyester, acrylonitrile-butadiene-styrene (ABS) copolymers, polyamide, polyurethane, polyether, polycarbonate, poly(oxide), poly(sulfide), polyarylate, polyetherketone, polyetherimide, polysulfone, polyurethane, polyvinyl alcohol, and polymers produced by polymerization of monomers, such as, for example, dienes, olefins, styrenes, acrylates, acrylonitrile, methacrylates, methacrylonitrile, polymers of diacids and diols, lactones, polymers of diacids and diamines, lactams, vinyl halides, vinyl esters, block copolymers thereof, and alloys thereof. Polymers yielding halogenated material upon pyrolysis, for example, polyvinyl chloride, polytetrafluoroethylene, and other halogenated polymers, can be corrosive but can be tolerated.

Polymer materials can also include thermoset polymers such as, for example, epoxy resins; phenolic resins; melamine resins; alkyd resins; vinyl ester resins; unsaturated polyester resins; crosslinked polyurethanes; polyisocyanurates; crosslinked elastomers, including but not limited to, polyisoprene, polybutadiene, styrene-butadiene, styrene-isoprene, ethylene-propylene-diene monomer polymer; and blends thereof.

Mixed polymer materials can also include sustainable biomaterials such as biopolymers. Biopolymers can be sustainable, carbon neutral and renewable, because they are made from plant materials which can be grown indefinitely. These plant materials come from agricultural non-food crops. Examples of biopolymers include, but are not limited to, polylactic acid (PLA) and polyhydroxyalkanoate (PHA) which are used in multi-layer sheet for food packaging applications.

Polymer material found in scrap material can have a combination of thermoplastic and thermoset polymers, for example, tires, paint, adhesive, automotive shredder waste (fluff), etc., and can be used as feedstock according to the various examples of the pyrolytic process herein.

Mixed polymer feed can include fillers, contaminants, etc. on average in the range of about 2% to about 25% by weight, in another example in the range of about 3% to about 20% by weight and in another example in the range of about 3% to about 15% by weight, and in yet another example less than about 7% by weight, all based on the average weight of solid feedstock.

In an example of any of the batch described above, the feedstock composition comprises from about 40% to about 90% by weight, in another example, from about 50% to about 85%, in another example from about 70% to about 80%, of one or more polymers of polyethylenes, polypropylenes, polyesters and optionally polystyrenes. The remaining polymers can include, but are not limited to, polyurethane, nylon, PET, and polyvinylchloride and the like.

Any of the feedstocks described above are introduced to the reactor as substantially shredded polymer, and in another example at least a portion of the feedstock can be present in other forms. For example, feedstock may be present in the form of molded or extruded polymer, sheet, film or multi-layer films, and foam sheet or molded products.

The size, for example weight of the plastic waste fed to any individual pyrolytic batch reactor, generally varies with the size of the reactor and can be from about 5% to about 80% full by liquid volume, or even higher as from about 80% to about 95% or lower such as from about 0.5% to about 5%, depending upon the size of the reactor.

This specification hereby totally incorporates by reference U.S. Pat. No. 10,711,202 as well as U.S. Pat. No. 11,118,114. It is noted that portions of these patents will be repeated since they generally incorporate the structure of the referenced batch reactors.

As noted, the present invention relates to an apparatus and a process for pyrolyzing plastic waste and producing various chemical compounds such as petroleum products, various gases, as well as a SIR (solid inert residue). The plastic waste material generally comprises any type of polymer waste or equivalence thereof. Various products include but are not limited to naphtha; distillate, (e.g. diesel, gasoline, heating oil, natural gas, kerosene, various C1-C5 alkanes); and gas oil (e.g. heavy oil and wax), and the like. The processes for producing petroleum products herein can yield at least 50%, in another example from about 50% to about 90%, in another example from about 60 to about 90%, and in another example from about 70% to about 90% fungible products. Example embodiments of the process herein can produce at least about 55% from about 60% to about 90%, in another example from about 70% to about 92% condensable gas based on the gas product generated by the process.

The process for producing petroleum products involves pyrolysis of a feedstock comprising mixed polymer and in situ reactions that produce solid inert residue, molten fluids, and gases inside the reactor vessel. A solid inert residue stream, a gas product stream, and a minor amount of a liquid stream exit the reactor. The mass conversion of the feedstock to condensable and non-condensable gas products occurs within the reactor vessel. Up to about 100% by weight of the condensable gas product is converted to usable fuel product, and up to 100% of the non-condensable gas can be used for fuel.

The term “batch process” herein refers to a process in which all the solid, semi-molten or molten reactants (feedstock) are placed in the reactor at the beginning of the process and is then processed according to a predetermined reaction process during which no additional feedstock is added to the reactor. It also relates to the sequential pyrolyzation of additional “batch” reactors wherein gas products, liquid products, and SIR are produced in each separate, or individual reactor, independently, in a time lapsed, interruption, manner. Thus, the following description relates to the various operational aspects of each individual reactor of the plurality of reactors that constitute the batch reactor process of the present invention. While the plurality of batch reactors are separately utilized to process a fixed amount to feedstock, it is to be understood that the separate, individual reactors, due to the nature of the feedstock, operational characteristics of the reactor, and the like, can operate in generally slightly different reaction modes such as with respect to a temperature of the individual batch reactor

The present invention comprises gas cracking reactions combined with condensation and recombination reactions to achieve desired gas product compositions exiting the reactor apparatus. One or more reactors are utilized, preferably a plurality of individual pyrolytic batch reactors to convert the plastic feedstock to various chemical compounds and/or gases. The process of producing petroleum products and/or gases includes the management of the reaction chemistry in the reactor vessel.

A great advantage of the batch process of the present invention is that instead of one long continuous 24/7 operation wherein the reactor can become plugged, fouled, break-down, etc., is that if one or more of the plurality of reactors becomes plugged, breaks down, fouled, etc., it is merely taken out of rotation and the batch process operation is continued whereby desirable chemical compounds and/or gases are produced.

Heat energy can be independently applied and withdrawn from a single reactor vessel. A temperature gradient exists within a reactor apparatus 11 between the bottom surface of the reactor vessel to the top portion of the reactor at a reactor outlet port. It has been found that the processes disclosed herein produce petroleum products of desired composition distributions from a wide variety of mixed polymers, including mixed polymer scrap. Feedstock of inconsistent composition mixtures can produce substantially the same targeted distribution of the same product compositions, i.e. the desired “composition distribution.” For example, the products produced by the process herein can include target compositions, the desired percentage range of each of naphtha, distillate, wax, and gas oil. The present invention exhibits controlled consistency in the petroleum product. The composition of hydrocarbonaeous feedstock material can vary from about 10% to about 70% polyethylene, from about 10% to 70% polypropylene, from about 10% to about 30% polystyrene and from about 0% to 30% of other commonly use polymeric materials, including but not limited to, polyvinyl chloride, polyester, polycarbonate, polymethyl methacrylate, nylon and the like. In another example, the feedstock comprises at least 40% by weight mixed polymer scrap which comprises at least 45% to about 70% or about 80% by weight of hydrocarbonaceous material.

FIG. 2 is a schematic illustration of a system or apparatus 11 for carrying out pyrolysis of mixed polymers in accordance with one aspect of the present invention. The reactor vessel 12 is surrounded by a shroud 7 that creates channels 8 and 9 to convey hot vapors from heaters H1 and H2 around the vessel 12. Baffle 25 allows dampening of the hot air to adjust the temperature and temperature profile inside the reactor and affect a temperature gradient along the vessel wall 10 top to bottom. Heaters H₁ and H₂ may be of any type, for example gas fired burners that impinge directly on the walls of reactor vessel, 12 or include diffusing plates above the burners to more evenly spread the heat on the bottom wall 14 of vessel 12. Inside the reactor is an agitator 4 that can be an anchor mixer, helical stirrer, or any other type of agitator that will scrape the bottom of the vessel and agitate the pyrolyzing plastic to keep good heat transfer.

Still referring to FIG. 2, feedstock 2 is input to the reactor in batches through port 3. The feedstock can be fed through an auger, extruder, airlock valves, and the like, and may be purged to exclude air from the reactor. Further, the reactor can be reduced in pressure to decrease the likelihood of leakage during charging of plastic, or plastic fed when the reactor is cold. The reactor is generally purged with an inert vapor such as nitrogen or steam before heating, although it is preferable for the reactor to stay purged of air between batches. The plastic is heated as through bottom wall 14, and vapor is removed through vapor port 13 in time stages to effect a separation of contaminants from the final product. For example, stage A would occur at the beginning of pyrolysis when the plastic temperature is lower, around 200° F. to 550° F. (93° C. to 288° C.). During stage A, the collected vapor will be rich in contaminants such as chlorides, sulfur, ammonia, and other heteroatom contaminants. This stage A vapor can be collected in a separate condenser, or drained from the product collection before the following stage, preventing the stage A product from mixing with final product from stage B. This allows for exclusion of contaminants from the final product. Stage B vapor, which is later in time during the pyrolysis when the plastic is hotter, for example between 650° F. to 1350° F. (343° C. to 732° C.), would be lean in the aforementioned heteroatom contaminants, and is condensed separately without mixing with Stage A condensate product. Both products could then go to clean up and other product recovery processes. This example contemplates only 2 stages, but it can be easily understood that any number of time phased stages can be used to achieve higher quality product both with regards to heteroatom contaminants, but also undesirable or desirable components such as paraffins, olefins, naphthenes, and aromatics in the hydrocarbon product. Operating the process in sequencing batch allows for this time staging that equates to temperature staging, which is not possible in a true continuous system. Batch operation further allows for other properties of the time stage to be varied to accomplish similar product quality results. For example, pressure may be varied between stages, additives can be added in stages to sorb contaminants, catalysts can be added between stages to effect desired reactions, mixing rate can be varied between stages, residence time can be varied between stages, and overall temperatures or temperature profiles can be varied to achieve desired results.

Further referencing FIG. 2, solid inert residue remaining after the plastic has been fully pyrolyzed is removed from the reactor vessel 12 through port 5 using an SIR removal system 6. This SIR removal system can be augers, pistons, sequencing airlock valves, or any other solids removal system. In order to make removal of the SIR safer, the SIR can be removed after the reactor apparatus cools down, and the pressure of the apparatus can be reduced to minimize the likelihood of leaks through the SIR system. Further, the reactor can be purged with an inert vapor such as nitrogen and the like to make the SIR removal safe. It is generally desirable to keep the reactor purged of air between runs to minimize down time, cool down times, and the risk of fire or formation of hazardous combustion byproducts. For example, if air is allowed into the reactor between batches when the reactor is not fully cooled down, or there is residual SIR that is still above its autoignition temperature, then the SIR can combust and potentially form dioxins, or convert heavy metals in the SIR into leachable forms that would render it hazardous.

To clarify how this invention works, the following narrative reflects what happens in a single reactor as it goes through its cycles. This same cycle would be performed by the other reactors in the sequencing batch system, but they would generally be at different stages in their cycles at any given point in time. The reactor, typically still devoid of air and still warm from the past cycle, is charged with fresh plastic through a feed unit that excludes air, such as an extruder, auger, sequencing airlock valves, or the like. The reactor is then directly heated from the bottom 14 by heaters H₁ and H₂, while agitating the plastic with a stirrer. As the plastic heats up, it first begins to offgas light volatile material such as steam, low boiling point organic contaminants, and the like. Initially, the top of the reactor will be at a temperature low enough that the vapors can condense on the wall and run by gravity back down into the melting plastic, where they are volatilized again by the heaters at the bottom of the reactor. Eventually, the reactor vessel is warm enough that they can leave the vessel through a vapor port where they can be condensed through a condensing system. As the reactor heats up to between 212° F., and 575° F. (100° C. and 302° C.), the plastic material will melt and the first contaminants will begin to be released. Chlorides, in particular from PVC resins, will be converted to HCl and released into the vapor phase. These contaminants are collected in a condenser through the vapor port. Once a targeted amount of these contaminants are released, typically measured by achieving a specific temperature set point, then the contaminants are drained from the condenser collection vessel. Alternatively, a separate vapor collection system can be used for the contaminants, in which case a valve can be used to divert vapors between stages of the reaction. The separate vapor collection system could be a condenser, or a sorption bed or process to collect the contaminants and ensure they are not released to the environment. Once the contaminant removal stage is completed, and the collected vapors separated from the balance of the process, then the temperature is raised to achieve complete pyrolysis of the plastic by monitoring temperatures at bottom 14 via measurement sensor 16. This can be between 800° F. and 1500° F. (427° C. and 816° C.). During pyrolysis, the plastic is heated from the bottom 14, maintaining a temperature differential between bottom 14 and top 26 of the reactor. The colder temperatures at the top of the reactor, which can be around 100° F. to 400° F. (38° C. to 204° C.) lower than the bottom of the reactor, allow for vapors to condense at the top of the vessel and reflux by gravity back down to the heated surface of the reactor. This reflux is important because it allows for very heavy hydrocarbons to be re-cracked to smaller hydrocarbons that are less likely to foul exchangers or piping. The vapor from the pyrolysis stage is collected through the vapor port and condensed in a condenser such as a direct contact condenser, shell and tube condenser, finned fan condenser, or the like. This second collected vapor is the desired product, containing lower quantities of contaminants as they were removed in an earlier stage. Once the pyrolysis is completed, as observed by measuring weight of the vessel, or stirrer power requirements, or vapor production rate, or vapor temperature, or other appropriate indicators, then the SIR removal process can begin. In the most preferred embodiment, the reactor stays at about the same temperature, and the SIR is stirred or conveyed to the SIR removal system at the bottom of the reactor. The SIR removal system can be an auger, extruder, pistons, double airlock valve, or similar apparatus that allows for solids removal while keeping a seal to exclude air from the reactor and keep hot hydrocarbon vapor from exiting the reactor. During the SIR removal step, pressure on the reactor can be reduced to decrease the likelihood of vapor leakage through the SIR removal system. Once the SIR is fully removed, then the reactor is ready to repeat the cycle with plastic addition to the vessel.

The process is anaerobic in operation. The term “anaerobic” refers to an environment which has a low, or near-zero, oxygen gas, O₂, or “free” or “unbound” oxygen content. That is, upon initial heating of the feedstock entering the reactor apparatus 11 and throughout the pyrolysis process, the reactor vessel 12 contains less than about 3% by volume oxygen, in an alternative embodiment, less than about 2% by volume oxygen, in an alternative embodiment, less than about 1% by volume oxygen, and in yet an alternative embodiment, from about 0.01% to about 1% by volume oxygen, based on the internal volume of the reactor vessel.

The loading of feedstock into reactor vessel 12 of reactor apparatus 11 with respect to any specific batch charged is controlled to accommodate the size and geometry of the reactor vessel.

The average area of loading of the feedstock takes into account the variations in the bed depth depending upon the reactor geometry. In the example embodiments described herein, the reactor has sufficient depth or diameter to enable formation of a layer of residual solids during pyrolysis and also sufficient head space above the feedstock to enable controlled gas phase cracking and recombination reactions. The reactor has at least about 30% free volume upon initial heating, in some embodiments at least about 60% free volume upon heating, and in alternative embodiment at least about 80% free volume upon heating, and in another embodiment from about 60% to about 99% free volume upon heating.

Product in the form of gaseous products and residual products (chemical compounds) can be collected from the reactor apparatus. The total gaseous products produced from reactor apparatus 11 comprises at least about 50%, in another example at least about 82%, in another example at least about 93%, and in another example at least about 96% by weight based on the weight of feedstock. The condensable hydrocarbons, based on the total gaseous products produced, vary from about 50% to about 98% by weight, in another example from about 60% to 90% by weight. For example, the condensable hydrocarbons produced includes from about 10% to about 60%, by weight, of at least one of the three streams for example, naphtha, distillate, or gas oil based on the weight of gaseous products produced. For example, the condensable hydrocarbons produced can comprise from about 10% to about 60%, in another example from about 15% to about 35% by weight of naphtha, from about 10% to about 60%, in another example from about 15% to about 35% by weight of distillate and from about 10% to about 60%, in another example from about 15% to about 35% by weight of fuel oil based on the weight of gaseous product.

Controlling the rate of gas formation and the type of molecules in the gas phase through cracking and reformation involves several control variables. For example, control variables include, but are not limited to the energy input to the reactor apparatus 11 or reactor vessel 12, the heat flux, the mass flow of the gas out of the reactor vessel 12, flow of gas, for example exhaust gas, along the outside of the reactor vessel, the residual solid layer thickness, horizontal thermal gradient, radial thermal gradient, the shape of the reaction chamber, ratio of residual solid, liquid, foam, gas zones, the location of product gas removal, the vertical temperature gradient, and gas product residence time.

At least one temperature sensing element, for example a thermocouple, is disposed within reactor apparatus 11 to provide an output signal which is representative of the temperature of any of reactor products in the gaseous state inside the reaction vessel. Reactor apparatus 11 can include temperature sensors in the vapor space 27 via sensor 28, at the bottom 14 heated section of the vessel 12 via sensor 16, in vapor outlet 13, SIR outlet 5, the channel between the shroud and vessel wall 10, and the like. If the measured temperature should be less than a predetermined temperature control value, the heat sources is adjusted to increase the heat input rate of the reactor. If the measured temperature in an area is greater than the predetermined temperature control value, then heat damper is adjusted to increase the mass flow rate of plenum gas or exhaust gas through the exhaust vent, for example.

Examples have been included to more clearly describe particular embodiments of the present invention and associated advantages. However, there are a wide variety of embodiments within the scope of the present invention, which should not be limited to the particular examples provided herein.

### EXAMPLES

The pyrolytic batch processing aspect of the present invention has been found to yield a relatively high output of various gases, liquid compounds, as well as relatively small amounts of a SIR compound. Examples of the process and apparatus for a high output of chemicals and gases derived from the systematic batch pyrolyzation of plastic waste feedstock is now set forth in the following examples.

During an extended batch run, samples were taken of condensed hydrocarbon and analyzed for chloride content using X-ray Fluorescence Spectroscopy. Chloride content at the beginning of the run was 606 parts per million. At the end of the run, chloride content in the hydrocarbon sample was 121 parts per million. This is an 80% reduction in chlorides. The relative prevalence of chloride at the beginning of the run suggests that chloride can be separated by operating in sequencing batch, where early product will preferentially contain chlorides and later product will be comparably low in chlorides. Chlorides and other halogens are undesirable in the final products as they can lead to corrosion in fuel applications or chemical feedstock applications. In a continuous process, the chlorides must be removed in post processing using an expensive operation such as hydrotreatment, which requires separate processes to provide hydrogen and high pressure, high temperature equipment with high capital costs.

At early stages in the batch pyrolysis, temperature steps can also be used to preferentially remove other heteroatoms that are not desirable for fuel or chemical feedstocks. For example, some nitrogen components of waste plastic feedstock can be removed at lower temperature (for example, 200° C. to 300° C., i.e. 392° F. to 572° F.) than bulk pyrolysis (350° C. to 700° C., i.e. 662° F. to 1,292° F.) as ammonia, and some sulfur compounds can be removed as hydrogen sulfide. The ammonia and hydrogen sulfide, along with hydrochloric acid that are volatilized at lower temperatures can be removed from the hydrocarbon steam by condensation as well as common adsorption or absorption processes to ensure they are not emitted to the environment or included in the final product.

During a batch run at an operating pressure of roughly 5 psig, hydrocarbon vapor leakage was detected from the SIR removal unit through detection of carbon monoxide on a gas detector. The pressure in the system was reduced to 1 psig, which eliminated the leak as evidenced by no carbon monoxide reading on the monitor.

While in accordance with the patent statues, the best mode and preferred embodiment have been set forth, the scope of the invention is not limited thereto, but rather by the scope of the attached claims.

What is claimed is:

1. A method of producing and recovering chemical compounds, or gas products, or both, from a plastic waste feedstock, comprising the steps of:
providing a plurality of individual pyrolytic batch reactors, said pyrolytic batch reactors independently capable of converting said plastic waste feedstock to chemical compounds, or gas products, or both, and also a Solid Inert Residue (SIR);
charging, independently, in a sequential time manner at least a first pyrolytic batch reactor and a second pyrolytic batch reactor with said plastic waste feedstock in an un-melted state;
heating the plastic waste feedstock, independently, in a sequential time manner in the first pyrolytic batch reactor and the second pyrolytic batch reactor and recovering a first gas product at a first time stage;
pyrolyzing said plastic waste feedstock, independently, in a sequential time manner in said first pyrolytic batch reactor and said second pyrolytic batch reactor; and
producing and emitting said chemical compounds, or second gas product, or both, as well as said solid inert residue (SIR) at a subsequent, second time stage in an independent time sequential manner from said at least first pyrolytic batch reactor and said second pyrolytic batch reactor.

2. The method according to claim 1, wherein at least said first pyrolytic batch reactor has a free volume of at least 60% based upon the amount of said plastic waste feedstock in said reactor; and wherein a pyrolyzing temperature of said at least first individual pyrolytic batch reactor is from about 500° F. (260° C.) to about 1500° F. (815° C.).

3. The method according to claim 2, wherein at least said first pyrolytic batch reactor has an amount of oxygen therein of less than about 3% by volume.

4. The method according to claim 3, wherein said at least one individual pyrolytic batch reactor has an amount of oxygen therein of less than about 2% by volume.

5. The method according to claim 2, comprising charging at least about 85% of all of said plurality of individual pyrolytic batch reactors with said plastic waste feedstock; pyrolyzing said plastic waste feedstock in said plurality of individual pyrolytic batch reactors, independently, and in a sequential time manner; and producing said chemical compounds, or gas products, or both, from said plurality of individual pyrolytic batch reactors.

6. The method according to claim 5, wherein each of said plurality of individual pyrolytic batch reactors, independently, have a plurality of heaters therein that are capable of forming a heated gas exchange medium.

7. The method according to claim 6, including an outer shroud that substantially surrounds each said plurality of individual pyrolytic batch reactors, and, independently, including a plurality of sequential reaction zones in each said plurality of shroud containing pyrolytic batch reactors, and wherein said plurality of pyrolytic batch reactors, independently, have a free volume of at least about 80% by volume.

8. The method according to claim 7, wherein said plurality of individual pyrolytic batch reactors, independently, have a plurality of inner walls that extend between said reactor and said outer shroud that, independently, form a plurality of fluid channels along the horizontal length of said reactor, said fluid channels capable of containing said heated gas medium therein.

9. The method according to claim 3, wherein said plastic waste feedstock comprises one or more of polyethylene, polypropylene, polyester, acrylonitrile-butadiene-styrene (ABS) copolymers, polyamide, polyurethane, polyether, polycarbonate, poly(oxide), poly(sulfide), polyarylate, polyetherketone, polyetherimide, polysulfone, polyurethane, polyvinyl alcohol, and polymers produced by polymerization of monomers including one or more of a diene, olefin, styrene, acrylate, acrylonitrile, methacrylate, and methacrylonitrile, polymers of diacids and diols, lactone, polymer of diacids and diamines, lactam, vinyl halide, vinyl ester, block copolymers thereof, and alloys thereof; and thermoset polymers comprising epoxy resin; phenolic resin; melamine resin; alkyd resin; vinyl ester resin; unsaturated polyester resin; crosslinked polyurethane; polyisocyanurate; and crosslinked elastomer, comprising polyisoprene, polybutadiene, styrene-butadiene, styrene-isoprene, ethylene-propylene-diene monomer polymer; and any combination thereof.

10. The method according to claim 3, wherein said plastic waste feedstock comprises polyethylene, polypropylene, polyester, polystyrene, polyurethane, polyamide, polymethyl methacrylate, polyvinyl chloride or any combination thereof.

11. The method according to claim 5, wherein said plastic waste feedstock comprises polyethylene, polypropylene, polyester, polystyrene, polyurethane, polyamide, polymethyl methacrylate, polyvinyl chloride or any combination thereof.

12. The method according to claim 3, wherein said produced chemical compounds comprise heating oil, gasoline, diesel fuel, kerosene, natural gas, wax, lubricants, naphtha, distillate, or any combination thereof.

13. The method according to claim 6, wherein said produced chemical compounds comprise heating oil, gasoline, diesel fuel, kerosene, natural gas, wax, lubricant, naphtha, distillate, or any combination thereof.

14. The method according to claim 7, including charging each said plurality of said individual pyrolytic batch reactors, independently, with said plastic waste feedstock, pyrolyzing each said plastic waste feedstock, independently, in said plurality of individual pyrolytic batch reactors and in a sequential time manner; and producing said chemical compounds, or gas products, or both, from each of said plurality of individual pyrolytic batch reactors.

15. The method according to claim 1, wherein the first gas product includes heteroatoms in order to reduce the content of the heteroatoms in said chemical compounds, second gas product and SIR.

16. The method according to claim 1, further including the step of removing halogens in the first gas product from the first pyrolytic batch reactor and second pyrolytic batch reactor prior to removing the solid inert residue.

17. An apparatus with a plurality of pyrolytic batch reactors, the apparatus comprising:
a shroud substantially surrounding each said pyrolytic batch reactor;
each said pyrolytic batch reactor, independently, comprising one or more inner walls that extend between said outer shroud and said pyrolytic batch reactor and define a plurality of fluid channels along the horizontal length of said reactor vessel, said fluid channels capable of containing a heated gas exchange medium therein;
each said plurality of pyrolytic batch reactors, independently, containing a free volume of at least 60%; and
wherein said plurality of said pyrolytic batch reactors, independently, are capable of sequentially cracking and reforming a plastic feedstock and producing chemical compounds, or gas products, or both, in a sequential time manner;
wherein the apparatus includes a first vapor collection system that receives a first gas product containing contaminants from a vapor port of at least one of the plurality of pyrolytic batch reactors, and
a second vapor collection system that receives a second gas product containing a desired product from a vapor port of at least one of the plurality of reactors.

18. The apparatus with the plurality of pyrolytic batch reactors according to claim 17, including a plurality of heaters, said heaters, independently, capable of heating said fluid channels with a gas medium, and further including a valve downstream from the vapor port that diverts the first gas product to the first vapor collection system or the second gas product to the second vapor collection system.

19. The apparatus with the plurality of pyrolytic batch reactors according to claim 18, wherein each separate pyrolytic batch reactor, independently, contains one or more reaction zones therein; wherein the first vapor collection system includes a sorption bed or a condenser.

20. The apparatus with the plurality of pyrolytic batch reactors according to claim 19, wherein each said pyrolytic batch reactor contains a mixer for advancing said plastic feedstock through said reactor; wherein the second vapor collection system includes a condenser.
